(19) United States
(12) Patent Application Publication
(10) Pub. No.: US 2020/0305451 A1
(43) Pub. Date: Oct. 1, 2020

(54) COMPOSITIONS OF ELECTROCHEMICALLY REDUCED PLANT-BASED EXTRACTS FOR CURING MEAT AND RELATED METHODS

(71) Applicant: KEMIN INDUSTRIES, INC., Des Moines, IA (US)

(72) Inventors: Lan Ban, West Des Moines, IA (US); Amanda Mardelle Houser, Slater, IA (US)

(21) Appl. No.: 16/833,592

(22) Filed: Mar. 28, 2020

Related U.S. Application Data
(60) Provisional application No. 62/825,266, filed on Mar. 28, 2019.

(51) Int. Cl. A23B 4/24; A23B 4/26; A23B 4/32

(52) U.S. Cl. CPC A23B 4/24; A23V 2002/00; A23B 4/325; A23B 4/26

(57) ABSTRACT

The present invention relates to electrochemically reduced nitrites from plant sources, such as vegetable extracts, where the plant-based extract contains nitrite in an amount sufficient to cure meat equally as effective to synthetic compounds when the dosage of nitrite was the same.

### CROSS-REFERENCE TO RELATED APPLICATIONS

This application claims the benefit of priority to U.S. Provisional Patent Application No. 62/825,266, filed Mar. 28, 2019, entitled “COMPOSITIONS OF ELECTROCHEMICALLY REDUCED PLANT-BASED EXTRACTS FOR CURING MEAT AND RELATED METHODS,” the disclosure of which is hereby incorporated herein by reference in its entirety.

### BACKGROUND OF THE INVENTION

The use of nitrite to cure meat was an ancient practice for producing stable and safe meat/poultry for human consumption. In old times, meat curing utilized bacteria starter culture that would turn nitrate into nitrite during curing process. However, bacteria culture (especially from the old practice which mixed cultures were normally utilized) requires delicate control as the culture needs to be kept alive and certain population in the bacterial culture needs to dominate (such as bacteria that contains nitrate reductase but no nitrite reductase) in order to produce consistent meat products, which made mass production of cured meat difficult. Sodium nitrite or potassium nitrite has been widely used instead of bacteria culture that delivers precisely what is required to make quality cured meat/poultry products.

Nitrite provides the desired pink color, characteristic taste, and food safety in cured meat products. While consumers demand natural alternatives, complete nitrite-free solutions cannot meet the desired curing characteristics and shelf life that nitrite provides, especially for the inhibition of spoilage bacteria and pathogens such as Clostridium botulinum. Natural curing strategies have been adapted in the United States that the nitrite would come from microbial conversion of natural nitrate in vegetables (Sebranek, J. G., Jackson-Davis, A. L., Myers, K. L., Lavieri, N. A. Beyond celery and starter culture: advances in natural/organic curing processes in the United States. 2012, Meat Science, Vol 92, 267-273). Based on the old practice that certain bacteria could reduce nitrate into nitrite, researchers have developed either single bacteria culture to be used in meat products, where nitrite would be generated in-situ under more controlled conditions (Lionel, G., Larnarliere, C. D., Martine, P., and Pascal, F. (Danisco A/S). Bacterial compositions of Staphylococcus vitulinus having nitrate reductase activity and of lactic acid bacteria and methods using these compositions. 2010, WO 2010067148 A1, Fast, B., Gaier, W., Gotz, F., Lindgren, P.-E., Neubauer, H., and Pantel, I. (Societe des Produits Nestle SA, Nestle SA). Nitrate reduction system of Staphylococcus carnosus, 1996. EP0805205A1) or produce nitrite containing vegetables juice as commercial products (Husgen, A., Bauman, K., McKlem, L., Papinaho, P., and Jones, B. (Kerry group services international, Ltd.) Method and composition for preparing cured meat products. 2008. US2008/0305213A1).

There is essentially no difference chemically between conventional nitrite and nitrite from converted vegetables. Various studies have shown that the microbial converted nitrite delivers the same curing performance as well as the same antimicrobial properties against pathogens when the same amount of nitrite was delivered to meat systems (Golden, M. C., McDonnell, L. M., Sheehan, V., Sindelar, J. J., Glass, K. A. Inhibition of Listeria monocytogenes in deli-style turkey breast formulated with cultured celery powder and/or cultured sugar-vinegar blend using storage at 4° C. 2014, Journal of Food Protection, Vol 77, 1787-1793, King, A. M., Glass, K. A., Milkowski, A. L., Sindelar, J. J. Comparison of the effect of curing ingredients derived from purified and natural sources on inhibition of Clostridium perfringens outgrowth during cooling of deli-style turkey breast. 2015, Journal of Food Protection, Vol 78 1527-1535, King, A. M., Glass, K. A., Milkowski, A. L., Seman, D. L., Sindelar, J. J. Modeling the impact of ingoing sodium nitrite, sodium ascorbate, and residual nitrite concentrations on growth parameters of Listeria monocytogenes in cooked, cured pork sausage. 2016, Journal of Food Protection, Vol 79, 184-193). Sufficient amount of nitrite in the end formulation is the key for both curing and food safety assurance, regardless of the source of nitrite.

While it has been an extensively studied area in nitrate treatment by electrochemical method for clean-up the environment, it has been not seen to utilize the method to produce natural nitrite from vegetable or plant sources for its use as food ingredients, especially in meat curing. The nitrite from fermentation of celery juice was shown to be effective in curing meat (Djeri, N. Evaluation of Veg Stable™ 504 celery juice powder for use in processed meat and poultry as nitrite replacer. 2010, Ph.D. dissertation, University of Florida). During fermentation process, nitrate from celery was selectively converted into nitrite, while bacteria growth also requires carbon and nitrogen source from carbohydrates/fibers, proteins from celery fiber/protein, and other external nutritional feed ingredients that was added to the culture broth. The negative taste could be from the combination of bacterial metabolites as well as from celery components. It has inspired interest on whether electrochemical processes could be utilized to convert nitrate into nitrite using vegetable extract, and the impact on sensory attributes and curing performance.

The idea of using electrochemical reduction on nitrate was not new (Li, H., Chambers, J. Q., and Hobbs, D. T. Electroreduction of nitrate ions in concentrated sodium hydroxide solutions at lead, zinc, nickel, and phthalocyanine-modified electrodes. 1998, this paper is not in a peer reviewed journal. It was prepared in connection with work done under contract NO. DE-AC09-76SR00001 with the U.S. Department of Energy; De Vooys, A. C. A., van Santen, R. A., and van Veen, J. A. R., Electrocatalytic reduction of nitrate on palladium/copper electrodes. 2000, Journal of Molecular Catalysis A: Chemical. Vol. 154, 203-215, Martinez, J., Ortiz, A., and Ortiz, I. State-of-the-art and perspectives of the catalytic and electrocatalytic reduction of aqueous nitrates. 2017, Applied Catalysis B: Environmental. Vol 207, 42-59, 12. Perez-Gallent, E., Figueiredo, M. C., Katsounaros, I., Koper, M. T. M. Electrocatalytic reduction of nitrate on copper single crystals in acidic and alkaline solutions. 2017. Electrochimica Acta. Vol. 227, 77-84, Birdja, Y. Y., Yang, J. and Koper, M. T. M. Electrocatalytic reduction of nitrate on tin-modified palladium electrodes. 2014. Electrochimica Acta. Vol 140, 518-524, Su, J. F., Ruzybayev, I., Shah, I., and Huang, C. P. The electrochemical reduction of nitrate over micro-architectured metal electrodes with stainless steel scaffold. Applied Catalysis B: Environmental. 2016. Vol. 180, 199-209, 15.

Mishra, S., Lawrence, F., Mallika, C., Pandey, N. K., Srinivasan, R., Mudali, U. K., and Natarajan, R. Kinetics of reduction of nitric acid by electrochemical method and validation of cell design for plant application. 2015, Electrochimica Acta. Vol. 160, 219-226). In wastewater treatment or other processes to eliminate nitrate, which is an environmental hazard, electrochemical reduction has been extensively explored. The reduction of nitrate includes series of reactions that would go through different intermediates. Each reaction in the cascade has its characteristic kinetics and thermodynamic behavior (Scheme 1), making it extremely hard to control the process towards desirable products.

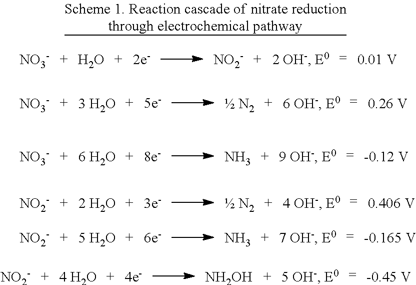

The reactions, however, might be able to be tuned by proper use of catalysts. It was widely known that this series of reactions need metal catalysts. The catalyst is required starting from the very first reaction (nitrate to nitrite). From literature, many types of catalytic systems were developed including copper, palladium, platinum, zinc, lead etc. And bi-metallic catalysts seem to work better than single metal catalyst (De Vooys, A. C. A., van Santen, R. A., and van Veen, J. A. R., Electrocatalytic reduction of nitrate on palladium/copper electrodes. 2000, Journal of Molecular Catalysis A: Chemical. Vol. 154, 203-215).

In the present application, lab scale electrochemical reduction was applied to various vegetable juices. The electrochemical converted juice was tested for its performance in representative meat and poultry systems and compared to conventional nitrite curing system, with the objective to establish proof of principles of electrochemical route to produce natural nitrite.

### SUMMARY OF THE INVENTION

The present invention relates to using an electrochemical process to yield plant-based extracts, such as vegetable extracts, that contain nitrite in an amount sufficient to cure meat, and in an amount that is equally as effective to synthetic compounds when the dosage of nitrite was the same. The inventors have unexpectedly found that reducing vegetable juice through electrochemistry presents an alternative pathway for arriving at naturally-sourced nitrite or plant-based nitrite that can be used to cure meat or poultry.

The unexpected discovery that electrochemically reduced plant extracts or vegetable juices can be used to cure meat or poultry differs from any existing or known methods, such as through fermentation. For instance, one advantage over fermentation is that the electrochemical process has less limitations with respect to the concentration of the nitrate that can be used in the process. In contrast to known fermentation processes, the process involves live cultures where the nitrate concentration may be limited or capped, because overloading will affect the life cycle of the microbes, or even kill the microbes.

Additionally, the present invention beneficially provides a vehicle for manufacturing additional compounds during the electrochemical process that may aid in the curing of the meat or poultry. This is in sharp contrast to known fermentation processes, where it is understood that the biological pathway to digest nitrate results in nitrite, while here the electrochemical pathway has the potential to work on multiple compounds at the same time resulting in multiple byproducts.

Finally, there are additional benefits of the present invention, including addressing consumer demand for naturally-sourced ingredients. There are also potential cost benefits compared to the costs associated with synthetic compounds or fermentation processes.

### DETAILED DESCRIPTION OF THE FIGURES

FIG. 1 is a photograph of the standard electrochemistry cell from Pine research instrument that was used to conduct reduction reaction. The left electrode is the reference electrode; the middle electrode is a standard carbon working electrode; and the right one is the counter electrode.

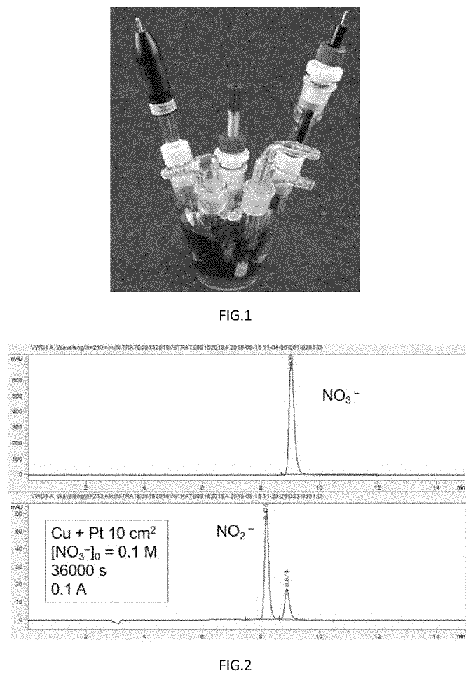

FIG. 2 depicts the chromatograms of 0.1 M sodium nitrate solution that was under either carbon as working electrode (upper) or Cu/Pt as electrode (lower), after 10 hours of constant current at 0.1 A.

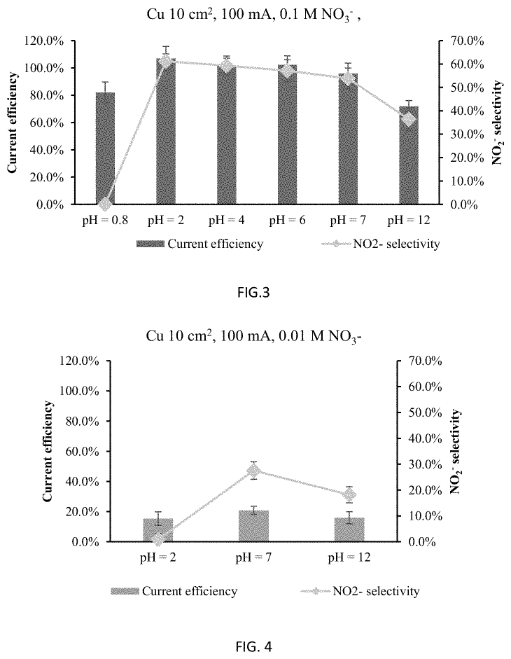

FIG. 3 depicts pH impact of current efficiency and nitrite selectivity for 60 min electrochemical reduction of synthetic nitrate at 0.1 M. Constant current of 100 mA was applied with 10 cm² copper wire as cathode (working electrode). Error bars represented standard error of means from two replicates.

FIG. 4 depicts pH impact of current efficiency and nitrite selectivity for 60 min electrochemical reduction of synthetic nitrate at 0.01 M. Constant current of 100 mA was applied with 10 cm² copper wire as cathode (working electrode). Error bars represented standard error of means from two replicates.

FIG. 5 depicts the current density impact (expressed as J) on current efficiency and nitrite selectivity for 60 min electrochemical reduction of synthetic nitrate at 0.01 M. Constant current of 100 mA and pH=2.0 were applied with copper wire of three different surface areas as cathode, separately (working electrode). Error bars represented standard error of means from two replicates.

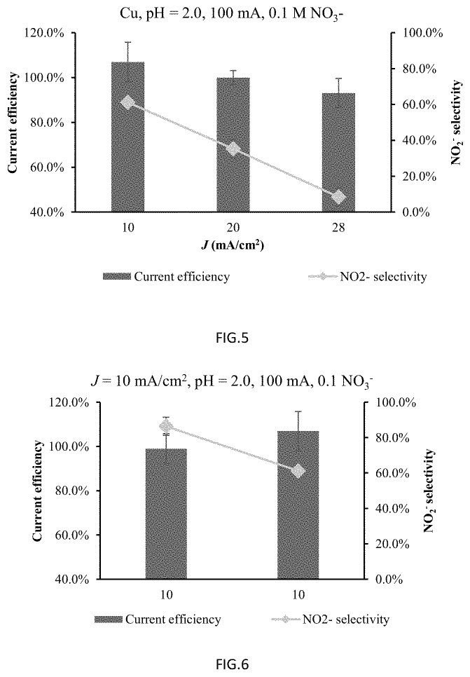

FIG. 6 depicts the cathode composition impact on current efficiency and nitrite selectivity for 60 min electrochemical reduction of synthetic nitrate at 0.01 M. Constant current of 100 mA with total working electrode surface area of 10 cm² and pH=2.0 were applied to either 100% copper wire (10 cm²), or to an intertwined metal wires made from Cu (6 cm² surface area) and Pt (4 cm²), separately. Error bars represented standard error of means from two replicates.

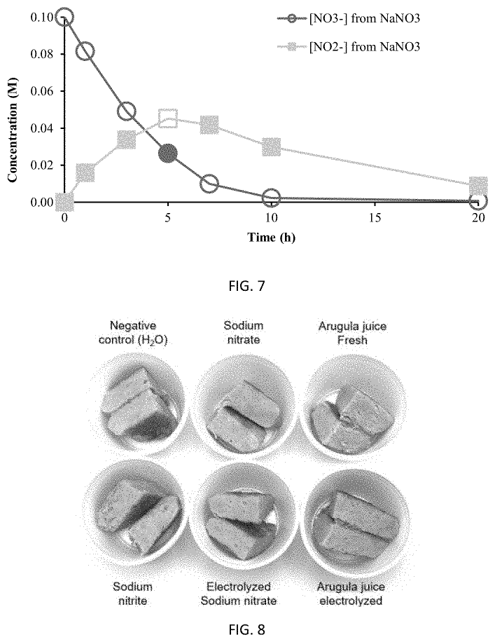

FIG. 7 depicts the change of nitrate and nitrite concentration over 20-hour electrochemical reduction. The conditions of the reaction are summarized in Table 3.

FIG. 8 shows the cured appearance of cooked ground pork containing synthetic nitrite, nitrite from electrochemical reduction of synthetic nitrate and electrolyzed arugula juice.

FIG. 9 shows the appearance of cured ground chicken patties from the second study on evaluating curing performance. Each piece represented a quarter of a patty from two replicates Top row, from left to right, untreated negative control, synthetic nitrite 200 ppm, natural nitrite 200 ppm from celery, natural nitrite 100 ppm from celery. Bottom row, from left to right, natural nitrite 100 ppm from celery, natural nitrite 200 ppm from arugula, natural nitrite 100 ppm from arugula.

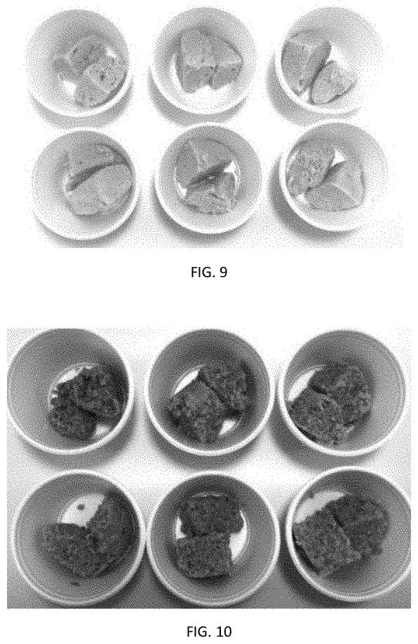

FIG. 10 shows the appearance of cured ground pork patties from the second study on evaluating curing performance. Each piece represented a quarter of a patty from two replicates. Top row, from left to right, untreated negative control, synthetic nitrite 200 ppm, natural nitrite 200 ppm from celery, natural nitrite 100 ppm from celery. Bottom row, from left to right, natural nitrite 100 ppm from celery, natural nitrite 200 ppm from arugula, natural nitrite 100 ppm from arugula.

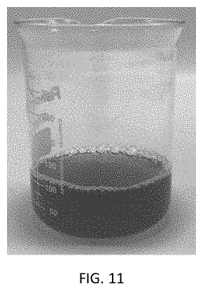

FIG. 11 depicts the appearance of electrolyzed arugula juice after 10 hours of reaction. The original nitrate concentration was 0.025 M.

### DETAILED DESCRIPTION OF THE INVENTION

The use of nitrite to cure meat was an ancient practice for preserving meat and poultry that is stable and safe for human consumption. Sodium or potassium nitrite has been widely used to cure meat/poultry products. For the past 10-15 years, however, consumers demanded more natural food ingredients to replace synthetic nitrite, which is considered a preservative. Based on the knowledge that certain bacteria could reduce nitrate into nitrite, researchers have developed either single bacteria culture to be used in meat products, where nitrite would be generated in-situ under more controlled conditions, Lionel, G., Larnarliere, C. D., Martine, P., and Pascal, F. (Danisco A/S). Bacterial compositions of Staphylococcus vitulinus having nitrate reductase activity and of lactic acid bacteria and methods using these compositions. 2010, WO 2010067148 A1; Fast, B., Gaier, W., Gotz, F., Lindgren, P.-E., Neubauer, H., and Pantel, I. (Societe des Produits Nestle SA, Nestle SA). Nitrate reduction system of Staphylococcus carnosus, 1996 (EP0805205A1) or alternatively to produce nitrite containing vegetables juice as commercial products (US2008/0305213A1, Method and composition for preparing cured meat products). The nitrite from fermentation of celery juice powder has shown to be effective in curing meat (Djeri, N. Evaluation of Veg Stable™ 504 celery juice powder for use in processed meat and poultry as nitrite replacer. 2010, Ph.D. dissertation, University of Florida). For a myriad of reasons readily appreciated by those of ordinary skill in the art, fermentation has drawbacks and is a less desirable process compared to other processes. In addition, one reported disadvantage to the fermented celery juice product has been that the taste and color from fermented celery juice causes a negative impact to the finished meat/poultry products.

The present invention relates to using an electrochemical process to yield nitrite compositions, for instance vegetable extracts that contain nitrite in an amount sufficient to cure meat, and in an amount that is equally as effective to synthetic compounds when the dosage of nitrite was the same. The inventors have unexpectedly found that reducing vegetable juice through electrochemistry presents an alternative pathway for arriving at naturally-sourced nitrite or plant-based nitrite that can be used to cure meat or poultry.

The unexpected discovery that electrochemically reduced plant extracts or vegetable juices can be used to cure meat or poultry differs from any existing or known methods, such as through fermentation. For instance, one advantage over fermentation is that the electrochemical process has fewer limitations with respect to the concentration of the nitrate that can be used in the process. In contrast to known fermentation processes, the process involves live cultures where the nitrate concentration may be limited or capped, because overloading will affect the life cycle of the microbes, or even kill the microbes.

Additionally, the present invention beneficially provides a vehicle for manufacturing additional compounds during the electrochemical process that may aid in the curing of the meat or poultry. This is in sharp contrast to known fermentation processes, where it is understood that the biological pathway to digest nitrate results in nitrite, here the electrochemical pathway has the potential to work on multiple compounds at the same time resulting in multiple byproducts.

Finally, there are additional benefits of the present invention, including addressing consumer demand for naturally-sourced ingredients. There are also potential cost benefits compared to the costs associated with synthetic compounds or fermentation processes.

According to at least one embodiment, the nitrite compositions are reduced plant-based extracts, more specifically vegetable extracts, such as extracts from any vegetable or leafy plant that contains between 0.1% to 100% nitrate can be used as a starting material. By way of non-limiting example, vegetables or leafy plants may include arugula, cabbage, brussels sprouts, celery, romaine lettuce, iceberg lettuce, kale and swiss chard. Persons of ordinary skill in the art would readily identify other plants and vegetables that would be appropriate starting materials within the scope of the present invention.

According to at least one embodiment, the nitrite composition is a reduced vegetable extract that can be used as a food ingredient that is capable of curing meat, poultry and seafood. In at least one embodiment, the reduced vegetable extract confers desirable properties on the cured meat product. In certain embodiments, the nitrite composition is a liquid or dry product.

### EXAMPLES

General Materials and Analytical Methods.

The chemicals and materials used are listed in Table 1. Milli-Q water (deionized water) was generated by an Ultrapure (Type I) water generator (Millipore, catalog number SYNSOHF00). The quantification of nitrate and nitrite followed established HPLC method (see Chou, S.-S., Chung, J.-C., and Hwang, D.-F. A high performance liquid chromatography method for determining nitrate and nitrite levels in vegetables. 2003, Journal of Food and Drug Analysis, Vol 11, 233-238). Briefly, reversed-phase column (C18, 150 mm×4.6 mm, 5 μm particle size) was used in the HPLC analysis, and both compounds could be detected at 213 nm. The run was isocratic with 30% methanol in 70% water (vol), which was supplemented with 10 mM octylammonium orthophosphate. Phosphoric acid was used to adjust the pH of the solvent system to 7.0.

TABLE 1
List of chemicals and materials used in this paper.

| Chemical | Supplier |
|---|---|
| Phosphoric acid (85%) | Fisher Scientific |
| Sodium nitrite, 99% | Sigma |
| Hydrochloric acid (37%) | Fisher Scientific |
| Acetonitrile, ACS grade | Fisher Scientific |
| Octylammonium | Fisher Scientific |
| orthophosphate | |
| Sodium nitrate, 99% | Sigma |

Lab Scale Electrochemistry Set-Up.

A potentiostat from Gamry instruments (Warminster, Pa. Model Interface 1000 T) was used to control the voltage between a working electrode and the reference electrode. The maximum current was ±100 mA. Maximum applied potential was ±5 V. The frequency range was from 100 mHz to 10 kHz.

The electrochemistry cell was a standard volume (100 mL) cell kit with glassy carbon working electrode (FIG. 1) from Pine Research Instrumentation (Durham, N.C. Item # WEB92-GC). The working electrodes that were tested include a standard carbon electrode with 3.00 mm in OD (Item # AFE1XFP303GCR), a standard platinum wire with OD of 6.9 mm, or coper wires (polished with sand paper in-house) that have various surface areas. The counter electrode is a standard platinum wire with OD of 6.9 mm, confined in a fitted glass isolation chamber to separate the counter electrode solution and the solution in the cell (Item # AFCTR5). The reference electrode is a single junction silver chloride electrode (Ag/AgCl, Item # RREF0021).

Synthetic nitrate reduction. Initially, the inventors attempted the reduction of nitrate using electrochemical processes disclosed in the literature that require metal catalysts such as copper, platinum, lead, palladium. (De Vooys, A. C. A., van Santen, R. A., and van Veen, J. A. R., Electrocatalytic reduction of nitrate on palladium/copper electrodes. 2000, Journal of Molecular Catalysis A: Chemical Vol. 154, 203-215; Martinez, J., Ortiz, A., and Ortiz, I. State-of-the-art and perspectives of the catalytic and electrocatalytic reduction of aqueous nitrates. 2017, Applied Catalysis B: Environmental. Vol 207, 42-59; Perez-Gallent, E., Figueiredo, M. C., Katsounaros, I., Koper, M. T. M. Electrocatalytic reduction of nitrate on copper single crystals in acidic and alkaline solutions. 2017. Electrochimica Acta. Vol. 227, 77-84; Birdja, Y. Y., Yang, J. and Koper, M. T. M. Electrocatalytic reduction of nitrate on tin-modified palladium electrodes. 2014. Electrochimica Acta. Vol 140, 518-524; Su, J. F., Ruzybayev., I., Shah, I., and Huang, C. P. The electrochemical reduction of nitrate over micro-architectured metal electrodes with stainless steel scaffold. Applied Catalysis B: Environmental. 2016. Vol. 180, 199-209; Mishra, S., Lawrence, F., Mallika, C., Pandey, N. K., Srinivasan, R., Mudali, U. K., and Natarajan, R. Kinetics of reduction of nitric acid by electrochemical method and validation of cell design for plant application. 2015, Electrochimica Acta. Vol. 160, 219-226). It was found that bimetallic catalysts were more effective in lowering the energy barrier of nitrate reduction. On the other hand, those metals could also be utilized as electrodes as they conduct electricity.

Next, the inventors evaluated the necessity of using transition metal catalyst. The electrochemical process was conducted with 80 mL solution each time. Sodium nitrate was dissolved in water at 0.1 M. No additional electrolytes were added. The working electrode was carbon and counter electrode was platinum coil. Constant current of 100 mA was applied to the solution for 10 hours. The solution was analyzed before and after the electrolysis for nitrate and nitrite. The second experiment was identical to the first one, except that the carbon electrode was switched to a combination of platinum coil which had 4 cm² surface area and a copper wire with 6 cm² surface area.

This initial attempt was to evaluate whether catalyst would be indeed required for nitrate reduction. The chromatograms after 10 hours reaction for carbon as working electrode (upper chromatogram) versus Cu/Pt as electrode (lower chromatogram) were shown in FIG. 2. There was no conversion of nitrate to nitrite with carbon electrode, while nitrite was formed with Cu/Pt electrode. It was hypothesized that most of the reduction reactions at carbon electrode was hydrolysis of water, as gas bubbles were constantly showing up, as water hydrolysis is a known side reaction when nitrate reduction happens by electrolysis. No quantification was performed at this stage.

Partial Lab Optimization of the Reduction Process Using Synthetic Nitrate.

The inventors concluded that the lab setting used in the first two experiments was not ideal for optimization of nitrate reduction. First, the electrochemical cell was intended to be used for reaction of very small quantity (milligram scale). Second, due to the very expensive price of transition metal electrodes, only copper wire with various length (which results in different surface area) and platinum coil with fixed surface area (the electrode was commercially purchased) were analyzed. The geometry, surface area and types of electrodes will impact the results of an electrochemical process, which will be subject to future research. Third, the electrochemical reduction of nitrate is a series of reactions that nitrite, nitric oxide, nitrous oxide, nitrogen and ammonia could all be produced. Due to instrumentation limit, only nitrite and nitrate were monitored. The objective of this partial optimization was to help understand the feasibility of nitrite production, with parameters that are easily controllable, including the concentration of nitrate, the pH of the solution and the surface area of copper wire. Two-dimensional experiments were conducted that for each set, one parameter would vary while all other parameters were fixed. Each run was allowed to proceed for 60 minutes. The current was always fixed at 100 mA. The reaction temperature was always kept at room temperature range (22-24° C.) and the pressure of the reaction was always at atmospheric pressure. Nitrate could also be used as electrolyte, so no other anions were added to the solution. The solution has a total nitrate of 0.1 M (could be from nitric acid, sodium nitrate or sodium hydroxide, depending on the pH requirement of certain experiments) except for one set of experiments that evaluated the concentration vs. electrochemical process efficiency. The reaction was agitated by a PTFE stir bar constantly at 250 rpm throughout the reaction. Each condition was replicated in two.

After each run, the selectivity to nitrite and the current efficiency of nitrate consumption were calculated following equation 1 and 2. In equation 1, consumed electrons could be calculated easily as the current was fixed. The total coulombs of electrons are the result of current times the reaction time. The coulombs could be converted into moles of electrons through Avogadro constant.

Current efficiency=Consumed nitrate (mol)/Consumed electrons (mol) Equation 1. Definition of current efficiency.

Nitrite selectivity=Nitrite produced (mol)/Nitrite consumed (mol) Equation 2. Definition of nitrite selectivity.

The first set of experiments evaluated optimal pH, where the pH of the solutions varied between 0-12. Nitrate acid or sodium hydroxide were used to achieve different pH. A copper wire with 10 cm² surface area was used as the working electrode. The counter electrode was still the platinum wire. The total nitrate concentration (combining sodium nitrate and nitric acid) was fixed at 0.1 M.

As shown herein, FIG. 3 depicts the results of current efficiency and nitrite selectivity of different pH when total nitrate concentration was kept at 0.1 M. pH=2.0 had resulted in the best combination of current efficiency as well as nitrite selectivity. Lower pH might result in excessive hydrogen production, which would take away the energy that was needed for nitrate reduction.

The second set of experiments evaluated whether there was any effect on pH while the total nitrate concentration changed to 0.01 M, as shown in FIG. 4. The current efficiency and nitrite selectivity were much less comparing to the identical conditions except for higher nitrate concentration, indicating that many side reactions were likely dominating the reduction reactions other than nitrate reduction. In the next runs in this report, only 0.1 M nitrate solutions were tested. For the future optimization studies, the optimized nitrate concentration in vegetable juice samples will be performed.

The third set of experiments evaluated the impact of current density, which was calculated by dividing current by the surface area of the working electrode. Copper was utilized as the working electrode because of the easiness to cut copper wire into different lengths. The optimal pH condition and total nitrate concentration were obtained from the first two sets of experiments discussed above. FIG. 5 has shown the results of current efficiency and nitrite selectivity of different current densities when total nitrate concentration was kept at 0.1 M. Because the current was held constant at 100 mA, the current densities could be made different by varying the surface area of the copper wires. Current density measured the current per surface area and is always an important parameter for electrochemical process. In this set of experiments, lower current density (10 mA/cm²) had resulted in the best performance for both selectivity and current efficiency, which translated into surface area of 10 cm² for the electrode. Future optimization and scale-up experiments might yield different results on the optimized current density, when electrodes materials, geometry or current/potential that would be applied to the solution change.

In the fourth set of experiments, two compositions of electrodes were tested. The first set still utilized 100% copper wire of 10 cm², the second electrode was a combination of copper (6 cm²) and platinum coil (4 cm²). The total surface area was kept the same for the two types of electrodes. The total surface area of 10 cm² and current density was based on the results from the third set of experiment (10 mA/cm²). The pH and nitrate concentrations were the same as in the third set of experiments (pH=2.0, total nitrate=0.1 M). FIG. 6 has shown the results. Nitrite selectivity was better using the bimetallic electrode while current efficiency was statistically not different (p>0.05). Future optimization and scale-up experiments might yield different electrodes or electrode compositions for optimizing the nitrite yield and throughput from vegetable juice electrolysis. Table 2 has summarized the partial optimization results.

TABLE 2
Partially optimized lab scale electrochemical reduction
conditions for synthetic nitrate solution. The temperature
range, solvent, pressure, counter electrode (Anode) and
current were fixed and not optimized in this study.

| Cathode | 60% Cu + 40% Pt |
|---|---|
| Anode | Platinum coil |
| Current density | 10 |
| (mA/cm²) | |
| Current (mA) | 100 |
| pH | 2.0 |
| Electrolyte | NaN0₃ + HNO₃ (total 0.1M) |
| Temp. (° C.) | 22-25° C. |
| Solvent | H₂O |
| Pressure (atm) | 1 |

Nitrate and Nitrite Concentrations Change Over Long Reaction Time.

Applying the optimal conditions obtained from the partial optimization (pH=2.0 by using nitrate acid as acidifier, starting total nitrate (from nitric acid and sodium nitrate)=0.1 M, working electrode=copper+platinum, total surface area of working electrode=10 cm²), the concentration of nitrate and nitrite were monitored over a period of 20 hours. Every 2-3 hours, a small sample solution of 0.1 mL was taken out and diluted in water (1000 fold dilution by volume) up to 10 hours and analyzed on HPLC for nitrate and nitrite concentrations. The last sampling point was at 20 hours (overnight reaction between 10-20 hours). The same set-up and volume of reaction solution (80 mL) was used. At the conclusion, the nitrate and nitrite concentrations were plotted against reaction time. FIG. 7 has plotted the concentration change of nitrate and nitrite over the 20-hour reaction time. At the end of the reaction, ammonia odor was detected. During the reaction course, nitrite would peak after 5 hours of reactions but declined after that, indicating that the consumption of nitrite would be faster than the accumulation of nitrate after a certain reaction time. This was also observed from previous investigations. For this specific set of conditions, harvesting the solution at 5 hours would maximize the selectivity of nitrite. The solution at 5 hours of reaction was used for testing curing performance later in this report.

Extraction of Vegetable Juices.

Arugula (Walmart and Hy-Vee in Des Moines, Iowa), Cabbage (Walmart and Hy-Vee in Des Moines, Iowa, and Whole Foods in West Des Moines, Iowa), Celery (Walmart in Des Moines, Iowa and Trader Joe's in West Des Moines, Iowa), Napa Cabbage (Walmart, Hy-Vee in Des Moines, Iowa, and Trader Joe's in West Des Moines, Iowa), Iceberg Lettuce (Walmart and Hy-Vee in Des Moines, Iowa, and Trader Joe's in West Des Moines, Iowa) were purchased from the local stores and processed using the same extraction method described as following. The vegetables were cut into ˜2 inch length strips and fed into a heavy duty food processor (KitchenAid), and processed for 1 min or until it is homogenized. For each 100 g of the cut vegetable, 50 g water was added to help with homogenization and extraction. The homogenized vegetable mixture was filtered using a coffee filter paper which was placed on top of a plastic funnel, through gravity filtration. After the majority of the juice went through the filter paper, the leftover wet solid was wrapped by the coffee paper and squeezed by hand to allow extra juice to filter through. The juice was analyzed for nitrate and nitrite concentrations by diluting it into water (100 fold dilution, w/vol), and filtered through PTFE syringe filter, before loading to HPLC. The nitrate weight percentage, relative to the fresh vegetable, was calculated by dividing the mass of nitrate in the juice over the mass of the fresh vegetable that was used for the extraction. Concentrations of nitrate in each vegetable. The concentration of nitrate (wt %) in fresh vegetables was summarized in Table 3. The concentrations vary according to the source of vegetables and the type of vegetables. Vegetables obtain their nitrate source from the soil through nitrogen fixation processes. Fertilizers which contain either inorganic or organic nitrate would help to upregulate the nitrate content in plants, although the nitrate content is also affected by the life cycle of the specific plant and other environmental conditions (Santamaria, P. Nitrate in vegetables: toxicity, content, intake and EC regulation. 2006, Journal of the Science of Food and Agriculture. Vol 86, 10-17.).

TABLE 3
Weight percent of nitrate in each fresh vegetable samples

| | Store (Des Moines Area) | | | | Average | |
|---|---|---|---|---|---|---|
| | | | | Whole | NO₃ % | Standard |
| Plant | Walmart | Hy Vee | Trader Joe's | Foods | (wt %) | Deviation |
| Arugula | 0.36% | | 0.39% | | 0.37% | 0.03% |
| Cabbage | 0.04% | 0.03% | | 0.06% | 0.04% | 0.02% |
| Celery | 0.08% | | 0.18% | | 0.13% | 0.07% |
| Napa cabbage | 0.11% | 0.13% | | 0.11% | 0.12% | 0.01% |
| Iceberg | 0.09% | 0.09% | 0.12% | | 0.10% | 0.02% |

As shown in Table 3, on average, the arugula contained most nitrate, followed by celery and napa cabbage. Those three were selected for electrolysis process feasibility evaluations.

Electrochemical Processing of Selective Vegetable Juice.

Arugula, celery and napa cabbage juices were selected for electrochemical reduction due to their relatively high concentration of nitrate. For each type of juice, water and sulfuric acid were added to adjust the total nitrate concentration to be 0.025 M and pH=2.0. The resulted diluted juice was filtered again through Whatman filter paper under house vacuum (Whatman #4 filter paper), and 80 mL filtrate was used for each run. The electrode composition and surface area were kept the same from the lab optimized conditions (working electrode=copper+platinum, total surface area of working electrode=10 cm²). The reason that the nitrate concentration was not standardized to be 0.1 M was because nitrate in the juice was not able to achieve such a high concentration. In the future, it is possible to pre-concentrate the juice to afford higher nitrate concentration, if it is determined that higher nitrate concentration would improve the throughput, nitrite selectivity and current efficiency. The reaction for each juice were replicated (N=2). The reaction time was set to be 20 hours initially, however, after one reaction with arugula juice, it was decided to shorten the total reaction time to be 10 hours as ammonia odor started to be obvious after around 12 hours of reactions. After 5 hours and 10 hours, a small sample (0.2 mL) was taken out and diluted with water (250 fold dilution by volume), filtered through PTFE filter and analyzed for nitrate and nitrite concentrations on HPLC. Table 4 summarizes the current efficiency and nitrite selectivity of each of the three vegetable juices after 10 hours of reactions and compared to the performance of synthetic sodium nitrate of the same starting nitrate concentration and reaction conditions. Current efficiency for the vegetable juices were much lower comparing to their synthetic counterpart, indicating that many other side reactions have consumed the electric energies. However, for the electrons that were used to reduce nitrate, the kinetics of nitrate reduction cascade was expected to remain similar regardless of whether the nitrate was in vegetable juice or was a standard compound in water solution, as evidenced by the similar nitrate selectivity among the four reaction processes.

TABLE 4
Electrochemical reduction of three vegetable juices for 10
hours, and comparison of the current efficiency and nitrite
selectivity to synthetic nitrate. The reaction conditions
followed Table 3, except for that total starting nitrate
concentration was 0.025M, instead of 0.1M in Table 3.

| | | | Napa | |
|---|---|---|---|---|
| | Arugula | Celery | cabbage | NaNO₃ |
| Current efficiency (%) | 10.5% | 14.4% | 17.3% | 52.4% |
| NO₂⁻ selectivity (%) | 36.6% | 31.8% | 34.2% | 30.5% |

### Example 1: Curing Meat Using Electrochemically Processed Vegetable Juice

The first application study was designed as a proof of principle to evaluate whether curing color could develop with the treatment of natural nitrite from electrochemical processed juice. Arugula juice that went through electrochemical reduction for 10 hours were used as a demonstration of curing color development, and compared to synthetic nitrite, nitrate and freshly prepared arugula juice that was not processed through electrochemical reduction. The recipe for making a cured ground pork model system and different treatments were summarized in Table 5. For the treatments that contain nitrite (either from electrochemical reduction or from synthetic sodium nitrite), the nitrite level in the “green” meat model system was always 200 ppm. Batch size of 100 g was performed for each replicate (N=2). The treatment from arugula juice was dosed that 200 ppm nitrite was delivered to the meat system. The meat model system was made from the following procedure. All the dry ingredients, except for sodium tripolyphosphate (STPP) and ground pork (Johnsonville, purchased from HyVee store, West Des Moines, Iowa), were weighed in a 3.5 oz plastic cup (#30135J6 Dart Solo, webstaurantstore.com, Lancaster, Pa.). In another 3.5 oz plastic cup, STPP and water were weighed and mixed, until all STPP dissolved (checked visually). For arugula treatment, the unprocessed or electrochemically processed juices were added to the STPP solution. The solution was transferred to the dry ingredients cup and stirred for 1 min with a glass rod. The entire solution was transferred on top of the ground pork in a Ziploc bag and sealed. The mixture was knitted by hand for approximately 2 min. All of the liquid was absorbed completely by the meat. Next, each mixture was made into round patties that each would fit into the shape of a 60 mm ID plastic petri dish (Fisher Scientific, # FB0875713A). One patty was made from one replicate. After the patty was formed, the petri dish would be inverted to remove the meat off the dish by gravity and moved on a stainless-steel baking sheet. After all of the patties were made the patties were cooked in gas oven (Jade), which was preset at 425° F., on one side for 15 min and was flipped and cooked for additional 4-5 min until an internal temperature reached 160° F. The cooked patties were allowed to cool down to room temperature (70-72° F.) on a parchment paper.

TABLE 5
Recipe (values are shown as wt %) for the cured ground pork model system for the
evaluation of electrochemically processed juice in curing color development. The
converted arugula juice was standardized to contain 0.02M nitrite. The concentration
of nitrite from conversation of synthetic nitrate was standardized to 0.05M.

| | | | | Non- | | Nitrite from |
|---|---|---|---|---|---|---|
| | | | | converted | Converted | conversion |
| | | Synthetic | Synthetic | arugula | arugula | of synthetic |
| Ingredient | Untreated | nitrite | nitrate | juice | juice | nitrate |
| Sodium | 0.400% | 0.400% | 0.400% | 0.400% | 0.400% | 0.400% |
| tripolyphosphate | | | | | | |
| Synthetic sodium | 0.000% | 0.030% | 0.000% | 0.000% | 0.000% | 0.000% |
| nitrite | | | | | | |
| Synthetic sodium | 0.000% | 0.000% | 0.037% | 0.000% | 0.000% | 0.000% |
| nitrate | | | | | | |
| Fresh arugula | 0.000% | 0.000% | 0.000% | 21.739% | 0.000% | 0.000% |
| juice | | | | | | |
| Electrochemical | 0.000% | 0.000% | 0.000% | 0.000% | 21.739% | 0.000% |
| converted | | | | | | |
| arugula juice | | | | | | |
| Electrochemical | 0.000% | 0.000% | 0.000% | 0.000% | 0.000% | 8.700% |
| converted | | | | | | |
| synthetic nitrite | | | | | | |
| Salt | 2.550% | 2.550% | 2.550% | 2.550% | 2.550% | 2.550% |
| DI water | 26.620% | 26.590% | 26.583% | 4.881% | 4.881% | 17.920% |
| Sodium | 0.040% | 0.040% | 0.040% | 0.040% | 0.040% | 0.040% |
| erythorbate | | | | | | |
| Ground pork | 70.390% | 70.390% | 70.390% | 70.390% | 70.390% | 70.390% |

In this first example, the performance of nitrite from different sources was evaluated for the cured color and taste (by informal sensory test). FIG. 8 depicts the appearance of cured ground pork from synthetic nitrite, nitrite from electrochemical reduction of synthetic nitrate and electrolyzed arugula juice. Each treatment has delivered the same amount of nitrite (200 ppm relative to the green weight of the meat product). The characteristic pink color showed up after cooking, as well as the characteristic cured flavor from informal sensory tests (using Hormel ham as comparison).

### Example 2: Curing Meat Using Electrochemically Processed Vegetable Juice

After initial success in developing the pink color using electrochemical converted arugula juice, additional experiments were conducted to focus on the curing performance with quantitative methods. Both converted celery juice (starting nitrite concentration=0.0079 M) and converted arugula juice (starting nitrite concentration=0.0091 M) that went through electrochemical reduction for 10 hours were used. The juice samples were concentrated using a rotary evaporator (Büchi, R-2). It was operated under house vacuum, with temperature of the water bath set at 70° C., until roughly 80%-85% of the mass was removed and the concentration of nitrite was slightly above 0.05 M. The resulted concentrated mixture was filtered through Whatman #4 filter paper (Fisher Scientific) on a Büchner funnel under house vacuum, to remove insoluble matters which accumulated during the concentration. Water was added to standardize the filtrate to contain 0.05 M nitrite.

In order to quantify the curing performance, ground pork, which represents red meat category, and ground chicken, which represents poultry, were selected to be treated by the converted juices. The fresh ground pork (C fresh market, ground at the counter from pork round steak, Des Moines) and ground chicken (Smart Chicken, Waverly, Nebr.) were purchased from local stores in Des Moines, Iowa. The ground pork in this second study had different visually larger particle sizes comparing to the first study. The recipe and treatments were shown in Table 6. The process of making ground pork/chicken patties followed the process described in Example 1, except for that the center temperature of the ground chicken patty reached 165° F.

TABLE 6
Recipe (values are shown as wt %) for the ground pork and ground
chicken model system for the evaluation of curing performance.*

| | | | Natural | Natural | Natural | Natural |
|---|---|---|---|---|---|---|
| | | Synthetic | nitrite 200 | nitrite 100 | nitrite 200 | nitrite 100 |
| | | nitrite = | ppm from | ppm from | ppm from | ppm from |
| Ingredient | Untreated | 200 ppm | celery | celery | arugula | arugula |
| Sodium | 0.400% | 0.400% | 0.400% | 0.400% | 0.400% | 0.400% |
| tripolyphosphate | | | | | | |
| Synthetic | 0.000% | 0.030% | 0.000% | 0.000% | 0.000% | 0.000% |
| sodium nitrite | | | | | | |
| Electrochemical | 0.000% | 0.000% | 8.700% | 4.350% | 0.000% | 0.000% |
| converted celery | | | | | | |
| juice | | | | | | |
| Electrochemical | 0.000% | 0.000% | 0.000% | 0.000% | 8.700% | 4.350% |
| converted | | | | | | |
| arugula juice | | | | | | |
| Salt | 2.550% | 2.550% | 2.550% | 2.550% | 2.550% | 2.550% |
| DI water | 26.620% | 26.590% | 17.920% | 22.270% | 17.920% | 22.270% |
| Sodium | 0.040% | 0.040% | 0.040% | 0.040% | 0.040% | 0.040% |
| erythorbate | | | | | | |
| Ground pork or | 70.390% | 70.390% | 70.390% | 70.390% | 70.390% | 70.390% |
| ground chicken | | | | | | |

*The converted arugula and celery juice were standardized to contain 0.05M nitrite.

Curing performance was evaluated following the suggested tests on meat color and residue nitrite level found in American Meat Science Association (AMSA) guidebook (American Meat Science Society, 2012, Meat Color Measurement Guidelines). First, subjective visual color was observed and compared to the synthetic control. The cooked patties were cut in quarters. A random piece from each replicate for the same treatment were used for photos with the center exposing up for the evaluation of cured colors.

Second, the objective color was measured by Hunter colorimeter (HunterLab Colorflex® 45/0, Hunter Associates Laboratory, Inc.). The colorimeter was standardized with black and white tiles. To reduce the effects of surface irregularities and improve measurement reproducibility, two measurements were taken for each sample, and the results were averaged for each sample. After the first measurement, the sample was repositioned over the colorimeter port, so the light beam contacted a different portion of the sample. Hunter colorimeter provides wavelength scan and record reflected light intensity of lights from 400 nm to 700 nm. The reflectance (reported as % R) at 650 nm and 570 nm were obtained. The ratio of the two was calculated and used as criteria of cured color development. If the value is ˜1.1, there is no cured color. A value between 1.7 and 2.0 indicated noticeable cured color; The value between 2.2 and 2.6 yielded excellent cured color (American Meat Science Society, 2012, Meat Color Measurement Guidelines).

Next, nitrosoheme (pink pigment) and total heme content (total pigments) in the patties were determined following AMSA recommended procedures 17. Nitrosoheme was formed during the heating of the meat products as a result of a cascade of reactions which starts from nitrite and myoglobin. Myoglobin is the pink pigment that is responsible for the typical cured meat color. The procedure of extraction nitrosoheme was performed in dark. The patties were homogenized in a coffee grinder (Hamilton Beach) first. The ground meat (10.00 g) was weighed into a 100 mL glass beaker. Next, 40 mL acetone and 3 mL DI water were added to the beaker and the mixture was agitated on a stir plate at 350 rpm using a Teflon stir bar for 10 min. By using the extraction solution, nitrosoheme can be extracted with maximum efficiency without extracting deoxymyoglobin, oxymyoglobin or metmyoglobin. The mixture was filtered through a Büchner funnel through a piece of filter paper (Whatman #1, Fisher Scientific). The filtrate (2 mL) was transferred to a cuvette (1 cm) and measured for its absorption at 540 nm using a UV-Visible spectrometer (GENESYS, Fisher Scientific), with 80% acetone/20% water (vol %) as blank. Nitrosoheme concentration, as expressed as ppm acid hematin, is calculated using Equation 3. Acid hematin (also named as hemin) is the oxidized products when all heme proteins were placed under acid conditions. Persons of ordinary skill would understand that acid hematin is a standard for determination of heme concentrations.

Nitrosoheme (ppm acid hematin)=A540×290 Equation 3. Calculation for nitrosoheme concentration in cured products

Total heme content (total pigment) was determined by the following procedure. The ground meat (10.00 g) was mixed with 40 mL acetone, 2 mL DI water and 1 mL HCl (37%) in a 100 mL beaker. The mixture was agitated on the top of a stir plate at 350 rpm for 1 hour and filtered through Whatman #1 filter paper through gravity force. This extraction method would extract all heme groups including the non-cured and cured meat pigments (deoxymyoglobin, oxymyoglobin, metmyoglobin and nitroso-heme containing myoglobin). The filtrate was loaded to a cuvette (1 cm) and its absorption at 640 nm was determined by the same UV-Visible spectrometer, with 80% acetone/20% water (vol %) as blank. The total heme, as expressed in ppm acid hematin, was calculated using Equation 4. Cure efficiency, which is defined as the percentage of total pigment converted to nitroso pigment, was calculated using Equation 5.

Total heme (ppm acid hematin)=A640×680 Equation 4. Calculation for total heme concentration in cured products

Curing efficiency (%)=(Nitrosoheme/total heme)×100 Equation 5. Calculation for total heme concentration in cured products

Finally, residue nitrite was measured in the cured pork and chicken patties. It is important to understand the residue nitrite level, which will impact the shelf life and food safety level of the meat products. The sample preparation method followed AMSA guidebook. Briefly, the homogenized pork or chicken patties (5.00 g) was mixed with 40 mL water that was preheated to 80° C. A glass rod was used to break up all lumps and the mixture was transferred to a 1 L volumetric glass bottle with a cap. The beaker and the rod were rinsed with additional hot water and all the wash solutions were transferred to the glass bottle. The volume of the mixture was fixed to be 300 mL by adding additional hot water, and the bottle was capped and allowed to sit in 80° C. water bath for 2 hours. Every 10-15 min, the glass bottle was agitated briefly by hand. Next, the mixture was cooled to be at room temperature and additional DI water was added to 500 mL mark. The mixture was agitated by hand for 30 seconds. A small portion was filtered through syringe driven Teflon filter to obtain 2 mL clear solution. AMSA guidebook used colorimetric assay to quantify the nitrite level in the prepared liquid sample.

In this study, this solution was loaded to HPLC using the same method as in previous sections, to quantify nitrite and nitrate concentration. Although the two methods were not compared in this study, HPLC is also a widely used and well recognized quantification method for residue nitrite determination.

Statistical analysis for curing performance. Each treatment was replicated (N=2) for each type of meat products. Each of the sample was analyzed two times for objective color analysis, nitrosoheme content, total heme content and residue nitrite level. Mean values were subjected to a one-way analysis of variance (ANOVA) with treatment as factors, using the STATGRAPHICS® Centurion XV software package. When the ANOVA was significant (p<0.05), differences between the treatments were assessed using Fisher's least significant differences.

Following AMSA guidance, a series of parameters were evaluated in two representative meat/poultry matrices. First, the curing color development for the ground chicken patties and ground pork patties were shown in FIG. 9-10. Chicken meat, especially the ground chicken used in this study, which are from “white meat”, had with less pinkish red color comparing to red meat. The developed color was visually observed for all the nitrite treatment groups but in general, less intense comparing to cured pork. There was no visual difference on the pink color intensity among nitrite treatment groups, regardless of the source of the nitrite for both chicken and pork.

Table 7 summarizes the quantitative measurements of the curing parameters for both chicken and pork patties. From the ratio of reflectance at 650 nm and 570 nm, the nitrite treated chicken matrices showed observable cured color (value between 1.7-1.8). However, as observed in the photo (FIG. 9), the pink color was not very intense, comparing to nitrite treated pork matrices (value between 2.2-2.4, FIG. 7 and FIG. 10). There were no statistical differences between the different dosages of natural nitrite treatments in the values of A650/A570 (p>0.05). However, there was statistically more nitrosoheme that was developed for 200 ppm nitrite treatment groups comparing to the lower dosage of 100 ppm nitrite (p<0.05) which resulted the higher curing efficiencies. Among the treatment groups which delivered the same amount of nitrite, there was no statistical differences among the different sources of nitrite on curing efficiencies, which were not unexpected.

TABLE 7
Parameters for the test of curing performance in the ground chicken and pork patties that were treated with nitrites from various
sources. The results were reported as mean ± standard deviation of two replicates, and two measurements for each replicate

| | | | | Natural | Natural | Natural | Natural |
|---|---|---|---|---|---|---|---|
| | | | Synthetic | nitrite 200 | nitrite 100 | nitrite 200 | nitrite 100 |
| | | | nitrite = | ppm from | ppm from | ppm from | ppm from |
| Species | Testing | Untreated | 200 ppm | celery | celery | arugula | arugula |
| Chicken | A650/A570 | 1.226 ± 0.005 | 1.714 ± 0.159 | 1.762 ± 0.010 | 1.736 ± 0.020 | 1.753 ± 0.015 | 1.757 ± 0.010 |
| | Nitrosoheme (ppm | N.A. | 9.8 ± 0.3 | 9.7 ± 0.3 | 8.1 ± 0.4 | 10.0 ± 0.2 | 8.2 ± 0.2 |
| | acid hematin) | | | | | | |
| | Total pigments | 14.6 ± 0.2 | 14.0 ± 0.4 | 13.7 ± 0.1 | 13.9 ± 0.1 | 14.0 ± 0.1 | 13.9 ± 0.1 |
| | (ppm acid hematin) | | | | | | |
| | Curing efficiency | N.A. | 69.7 ± 2.8 | 71.0 ± 2.8 | 58.1 ± 2.6 | 71.2 ± 1.0 | 58.9 ± 1.9 |
| | (%) | | | | | | |
| | Residue nitrite | N.D. | 70.5 ± 5.7 | 84.4 ± 4.4 | 36.2 ± 1.9 | 80.1 ± 5.2 | 35.8 ± 2.4 |
| | (ppm) | | | | | | |
| Pork | A650/A570 | 1.313 ± 0.002 | 2.295 ± 0.022 | 2.318 ± 0.063 | 2.253 ± 0.036 | 2.369 ± 0.064 | 2.176 ± 0.065 |
| | Nitrosoheme (ppm | N.A. | 87.8 ± 3.0 | 87.2 ± 3.6 | 75.6 ± 3.4 | 87.1 ± 4.6 | 73.4 ± 2.2 |
| | acid hematin) | | | | | | |
| | Total pigments | 111.3 ± 4.3 | 108.5 ± 2.9 | 108.3 ± 7.5 | 105.5 ± 5.7 | 106.8 ± 7.9 | 107.4 ± 7.9 |
| | (ppm acid hematin) | | | | | | |
| | Curing efficiency | N.A. | 80.9 ± 2.7 | 80.6 ± 2.5 | 71.9 ± 6.5 | 81.7 ± 3.8 | 68.5 ± 3.1 |
| | (%) | | | | | | |
| | Residue nitrite | N.D. | 59.5 ± 3.2 | 63.5 ± 2.4 | 38.0 ± 3.8 | 63.4 ± 2.6 | 38.0 ± 2.0 |
| | (ppm) | | | | | | |

There were sufficient amounts of nitrite that remained in the meat/poultry matrices after cooking. As discussed in the introduction section, residue nitrite is very important for assuring food safety and will act against spoilage and pathogenic microbes. The antimicrobial activity of the residue nitrite was not tested in this study, however, many previous literatures have suggested that as long as sufficient nitrite is left in the meat system (as little as 20 ppm would be effective to inhibit Clostridium botulinum (Johnston, M. A., Pivnick, H., Samson, J. M., Inhibition of Clostridium Botulinum by sodium nitrite in a bacteriological medium and in meat, 1969, Canadian Institute of Food Technology Journal, Vol 2, 52-55)), regardless of the nitrite source (Golden, M. C., McDonnell, L. M., Sheehan, V., Sindelar, J. J., Glass, K. A. Inhibition of Listeria monocytogenes in deli-style turkey breast formulated with cultured celery powder and/or cultured sugar-vinegar blend using storage at 4° C. 2014, Journal of Food Protection, Vol 77, 1787-1793), it would satisfy the needs for the general food safety and shelf life requirement.

### CONCLUSIONS

The investigators surprisingly found that electrochemically processed nitrate solution can be used to cure meat/poultry, either from synthetic nitrate or plant-based natural nitrate sources, such as plant-derived extracts including without limitation vegetable extracts or juice.

While the concept of using electrochemical reduction on nitrate has been known academically and with limited application in waste water treatment as a mechanism for eliminating nitrate, which is an environmental hazard, the inventors have surprisingly found that electrochemical reduction is a viable alternative for converting nitrate to nitrite in order to produce a naturally-sourced food ingredient.

Persons of skill in the art would appreciate that the reduction of nitrate includes series of reactions that go through different intermediates, where each reaction in the cascade has its characteristic kinetics and thermodynamic behavior (Scheme 1), making it extremely hard to control the process towards desirable products, particularly where the reaction cascade is not supposed to accumulate nitrite from thermodynamic standpoint.

In spite of the difficulty in controlling this reaction, the inventors have unexpectedly found that through carefully designed parameters, it is possible to reduce nitrate present in vegetable juice into nitrite that can be used as a food ingredient, for instance as an ingredient for curing meat and poultry. Further still, the inventors have found that the composition from the processed plant based vegetable juices are able to satisfy the curing performance requirements that are set up for synthetic nitrite, by the scientific community, such as American Meat Science Society.

In summary, the inventors have found that it is possible to reduce nitrate to nitrite and accumulate sufficient quantities, through an electrochemical process using a natural, and that reduced vegetable juice is capable of curing meat. In alternative embodiments, the reduced vegetable juice can be used to cure meat and poultry with satisfactory performance.

In another aspect of the present invention, the inventors surprisingly found that the naturally-sourced nitrite could achieve similar results to synthetic nitrite when used to cure meat and poultry products, and that advantageously the reduced vegetable juice resulted in desirable characteristics in appearance, taste, curing pigment development and residue nitrite in the cured meat/poultry following official standards for curing ingredients.

In alternative embodiments, persons of skill would appreciate that vegetables with varying amounts of nitrate/nitrites can be used in order to obtain the most desirable chemical profile for electrochemical reduced vegetable juice.

It should be further appreciated that minor dosage and formulation modifications of the composition and the ranges expressed herein may be made and still come within the scope and spirit of the present invention.

Having described the invention with reference to particular compositions, theories of effectiveness, and the like, it will be apparent to those of skill in the art that it is not intended that the invention be limited by such illustrative embodiments or mechanisms, and that modifications can be made without departing from the scope or spirit of the invention, as defined by the appended claims. It is intended that all such obvious modifications and variations be included within the scope of the present invention as defined in the appended claims. The claims are meant to cover the claimed components and steps in any sequence which is effective to meet the objectives there intended, unless the context specifically indicates to the contrary.

The foregoing description has been presented for the purposes of illustration and description. It is not intended to be an exhaustive list or limit the invention to the precise forms disclosed. It is contemplated that other alternative processes and methods obvious to those skilled in the art are considered included in the invention. The description is merely examples of embodiments. It is understood that any other modifications, substitutions, and/or additions may be made, which are within the intended spirit and scope of the disclosure. From the foregoing, it can be seen that the exemplary aspects of the disclosure accomplishes at least all of the intended objectives.

1. A composition for curing meat that contains a natural nitrite in an amount sufficient to cure meat, wherein the nitrite is electrochemically-reduced from a plant source.

2. The composition of claim 1 wherein the plant source is a vegetable or leafy plant that contains nitrate.

3. The composition of claim 2, wherein the vegetable or leafy plant is selected from the group consisting of arugula, cabbage, brussels sprouts, celery, romaine lettuce, iceberg lettuce, kale, and swiss chard.

4. The composition of claim 1, wherein meat refers to land animals, poultry, or any species that contain myoglobin to produce cured meat pigment.

5. The composition of claim 1, wherein the naturally-derived nitrite composition is capable of achieving the same or improved results when compared to the results of an equivalent dosage of a synthetic nitrite.

6. The composition of claim 1, wherein the composition is liquid or dry.

7. A method of curing meat comprising the step of applying an effective amount of a naturally-derived nitrite composition to the meat, wherein the nitrite composition is electrochemically-reduced from a vegetable source.

8. The method of claim 6 wherein the plant source is a vegetable or leafy plant that contains nitrate.

9. The method of claim 8, wherein the vegetable or leafy plant is selected from the group consisting of arugula, cabbage, brussels sprouts, celery, romaine lettuce, iceberg lettuce, kale and swiss chard.

10. The method of claim 7, wherein meat refers to land animals and poultry, or any species that contain myoglobin to produce cured meat pigment.

11. The method of claim 7, wherein the naturally-derived nitrite composition is capable of achieving the same or improved results when compared to the results of an equivalent dosage of a synthetic nitrite.

12. The method of claim 7, wherein the composition is liquid or dry.

13. A system for curing meat comprising using a plant-based nitrite composition, wherein the plant-based nitrite composition is prepared from a vegetable extract that has been electrochemically-reduced, and wherein the plant-based nitrite contains nitrite in an amount sufficient to cure meat equally as effective to synthetic compounds when the dosage of nitrite was the same.

14. The system of claim 13 wherein the plant source is a vegetable or leafy plant that contains nitrate.

15. The system of claim 14, wherein the vegetable or leafy plant is selected from the group consisting of arugula, cabbage, brussels sprouts, celery, romaine lettuce, iceberg lettuce, kale and swiss chard.

16. The system of claim 13, wherein meat refers to land animals and poultry, or any species that contain myoglobin to produce cured meat pigment.

17. The system of claim 13, wherein the composition is liquid or dry.
